(19) United States
(12) Patent Application Publication
(10) Pub. No.: US 2018/0022544 A1
(43) Pub. Date: Jan. 25, 2018

(54) COMMERCIAL GRADE UTILITY REFUSE RECEPTACLE AND WHEELED DOLLY

(71) Applicant: Suncast Technologies, LLC, Palm Beach Gardens, FL (US)

(72) Inventors: Brian C. Donnelly, Naperville, IL (US); Michael R. Vogler, Oswego, IL (US)

(21) Appl. No.: 15/216,314

(22) Filed: Jul. 21, 2016

(51) Int. Cl. B65F 1/14; B29C 49/42; B29C 49/20; B29C 49/64; B65F 1/16; B29C 49/04

(52) U.S. Cl. CPC B65F 1/1473; B65F 1/1452; B65F 1/1615; B29C 49/04; B29C 49/20; B29C 49/64; B29C 49/4278; B65F 2230/116; B65F 2250/114; B29L 2031/7126

(57) ABSTRACT

A receptacle including a body configured to receive refuse items and a mated handle is disclosed. The handle includes a base plate and a gripping portion connected by one or more sidewalls. The back side of said base plate contains a projection to allow the handle to mate with the body of the receptacle. The projection includes two regions offset from each other so that, when the body of the receptacle is formed by blow molding, the body can fill around the projection, thereby securely attaching the two. The handle can further include a cinch so that if a liner is used within the body of the receptacle, there is a place to tie it off on the handle. Multiple handles can be mated to a single receptacle body.

### FIELD OF THE INVENTION

This invention relates generally to a refuse receptacle and, in particular, to a blow molded utility refuse receptacle having an injection molded handle designed to securely lock to the body of the refuse receptacle during the formation of the receptacle body, and designed to mate with a structural foam-injection molded wheeled dolly.

### BACKGROUND OF THE INVENTION

Receptacles, or containers, for refuse have a variety of useful applications and are available in a number of different sizes. For example, large receptacles of 44 or 55 gallons are commonly used for disposal of trash, grass, leaves, and other materials. These large sizes of trash receptacles can be difficult to move as a person attempts to move the receptacle to a dumpster or other place where the contents of the receptacle can be emptied.

Some receptacles come with attached wheels to allow a person to wheel the receptacle to the curb or other place where it can be picked up. These are commonly used at homes where trash and recycling containers are filled with refuse from the home and then wheeled to the curb once or twice a week so that they can be emptied by city waste management.

Commercial refuse receptacles, however, generally come in cylindrical shapes without attached wheels. When these need to be moved, they are often dragged across the ground, often on the corner to decrease friction and allow them to be dragged with less effort. Dragging these receptacles on a corner can wear down the plastic that forms the body of the receptacle and lead to holes or cracking over time. This can also lead to excess stress on the handles and upper rim of the receptacle, which can lead to wear and cracking.

Alternatively, dollies have been employed to allow for easier transportation of refuse containers. Common dollies employ a variant of a “bayonet” or screw attachment design. In this type of design, the container is placed onto the dolly, or the container is inverted and the dolly is placed onto the container, and the mating bayonet flights or threads between the container and dolly are engaged. The dolly and container are then rotated with respect to one another until the dolly and container have been drawn up snugly against one another.

If the container is not inverted, a user must place the container upright on the dolly, grasp the dolly between their feet, and rotate the container to tighten the container down. Often times a user cannot be certain that the engagement has been successfully accomplished or sufficiently tight to avoid a disastrous and unexpected separation of the dolly from the container.

Alternatively, a user must bend down and hold the dolly with one hand while attempting to rotate the container with the other hand. This exposes the user to the accumulated dirt and other contaminants on the dolly, and again, cannot be accomplished with absolute certainty that the engagement was successful. For users with physical limitations, such a procedure can be impossible.

Receptacles are commonly manufactured by extrusion blow molding, injection molding, and rotational molding. Extrusion blow molding is the easiest and cheapest method for making hollow plastic receptacles. However, blow molding typically does not allow for the formation of durable handles that can withstand heavier weights when grasped. Injection molding, on the other hand, allows for the creation of more durable handles that can be made as part of the receptacle body. However, the injection molding process is more costly and takes more time.

Blow molding is a manufacturing process by which hollow plastic parts are formed. The blow molding process starts with melting down the plastic and forming it into a parison. The parison is a tube-like piece of plastic. This parison is then extruded into a chamber where it is captured by closing it into a cooled metal mold. Air is then blown into the parison, inflating it to fill into the shape of the hollow shape of the mold. After the plastic has cooled sufficiently, the mold is opened and the part is ejected. Additional plastic can then be trimmed off of the newly formed hollow piece.

### DESCRIPTION OF THE PRIOR ART

U.S. Pat. No. 5,758,888 describes a container and dolly assembly comprising a container having a planar rearward side and a lid that is pivotally coupled to one of the container handles and pivots thereabout into a vertical orientation against the container. Retention flanges of the container and the lid, respectively, overlap to lock the lid in the open position. The dolly is provided having upwardly directed tine members that engage flanges on the container as the container is lowered upon the dolly and latch the container and dolly together. A pivotal foot pedal is operable to laterally move one dolly tine member and thereby facilitate disengagement of both container flanges from the dolly tine members.

U.S. Pat. No. 5,865,338 describes a method of blow molding a hollow article, comprising the adaption of a die pin to include spaced apart channels therein that extend from top to bottom along the sides of the die pin. The channels are reinforcement ribs along the inside surface of a formed parison. The ribs expand with the parison into a final form and serve to reinforce the resultant body while being visible only from the inside. The channels are each bifurcated to provide a segment below a shut-off surface in which plastic exiting the die pin can expand to form ribs of substantial thickness. Portions of the parison sidewalls between the ribs are thinned to reduce part weight, and the ribs reinforce the sidewalls to compensate, yet, being visible only from the inside, do not detract from the external appearance of the receptacle.

U.S. Pat. No. 7,712,623 describes a receptacle with a vent enabling fluid communication from a first chamber section at the bottom of the receptacle to a second chamber section which rests above the first chamber section, which reduces the suction, or vacuum, effect in the bottom portion of the receptacle as trash bags or polyliners are removed therefrom.

U.S. Pat. No. 8,757,428 describes a refuse carrying device with a variety of handling features, including an attachable secondary handle, an attachable wheel assembly, and a shoulder resting recess. The durable container has an open top adapted for receiving refuse, with opposing sides of a top edge including a pair of handles. A selectably attachable, secondary, side handle and a selectably attachable wheel assembly are positioned along an outer lower perimeter edge of the container. The shoulder recess is an indentation along the lower perimeter edge opposite the secondary handle, and includes an attachable padded cushion to line the recess.

U.S. Pat. No. 8,807,381 describes a receptacle or container for refuse that includes a body configured to receive a liner and a cinch disposed on the body. The cinch includes a projection disposed outward of the body, and is configured such that at least a portion of the liner can be disposed between the projection and the body. The cinch further includes a slot having an open end and a closed end, wherein the slot is disposed substantially adjacent the projection and configured such that at least a portion of the liner can be disposed and retained within the slot.

U.S. Pat. No. 9,027,778 describes a receptacle comprising a container, a first standoff, and an air-permeable support, configurable for the removal of air or atmosphere from a container while preventing solids and liquids from entering a means for removing the air.

U.S. Pat. No. 9,050,995 describes a device for transporting a plurality of refuse containers across either a support surface or a winter surface, including a housing which is partitioned into a plurality of compartments, each compartment being shaped and dimensionalized to receive a refuse container.

The above cited references are incorporated herein by reference.

Accordingly, lacking in the prior art is a way of reinforcing the strength of the handles on blow molded refuse receptacles, allowing for increased strength and durability of the overall receptacle.

### SUMMARY OF THE INVENTION

The present invention relates to trash receptacles, and more specifically, to a receptacle including a body configured to receive refuse items having a handle mated to the receptacle with blow molded plastic. The handle includes a base plate and a gripping portion connected by one or more sidewalls. The back side of said base plate contains a projection to allow the handle to mate with the body of the receptacle during the blow molding process. The projection includes two regions offset from each other so that, when the body of the receptacle is formed by blow molding, the body can fill around the projection, thereby securely attaching the two together. The handle can further include a cinch so that, if a liner is used within the body of the receptacle, there is a place to tie it off on the handle. Multiple handles can be mated to a single receptacle body in the same manner.

Accordingly, it is a primary objective of the instant invention to provide a trash receptacle having at least one handle secured to the receptacle during the blow molding process.

It is a further objective of the instant invention to provide a method of attaching a handle to a trash receptacle during manufacture thereof.

It is yet another objective of the instant invention to provide a handle for a trash receptacle that includes features allowing attachment during the blow molding process.

It is further an objective of the instant invention to provide a trash receptacle that includes compression molded portions for high wear properties.

It is a still further objective of the instant invention to provide a trash receptacle having compression molded upper and lower rim portions.

It is an additional objective of the instant invention to provide a method of compressing portions of the trash receptacle during a blow molding manufacturing process.

It is yet another additional objective of the instant invention to provide a trash receptacle having integrally formed dolly attachment means.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a top left isometric view of one embodiment of a commercial grade refuse receptacle and wheeled dolly;

FIG. 2 is a top left isometric view of the refuse receptacle illustrated in FIG. 1 having the lid and wheeled dolly removed;

FIG. 3 is a bottom isometric view of the refuse receptacle illustrated in FIG. 1;

FIG. 4 is a top view of the refuse receptacle illustrated in FIG. 1;

FIG. 5 is a top left isometric view of one embodiment of a refuse receptacle lid suitable for use with the present refuse receptacle;

FIG. 6 is a partial isometric view illustrating the handle attached on the refuse receptacle;

FIG. 7 is a top right isometric view of the handle illustrated in FIG. 6;

FIG. 8 is a partial isometric view of an alternate embodiment of the attached handle with logo aperture secured on a refuse receptacle;

FIG. 9 is a rear isometric view of the handle with logo aperture illustrated in FIG. 8;

FIG. 10 is a cross sectional view taken along lines 10-10 of FIG. 8, illustrating the mating of the handle to the body of the refuse receptacle;

FIG. 11 is a bottom isometric view of the refuse receptacle;

FIG. 12 is a top isometric view of one embodiment of an attachable wheeled dolly;

FIG. 13 is a partial view of a base handle which also functions as an attachment for the wheeled dolly;

FIG. 14 is a partial section view taken along lines 14-14 of FIG. 1, illustrating the engagement of the dolly clips with the base handle portion of the refuse receptacle;

FIG. 15 is a partial section view taken along lines 15-15 of FIG. 2, illustrating a portion of the top rim of the refuse receptacle;

FIG. 16 is a partial section view taken along lines 16-16 of FIG. 2, illustrating a portion of the bottom rim of the refuse receptacle;

FIG. 17 is a perspective view of a plurality of refuse receptacles illustrated in a nested shipping or storage configuration;

FIG. 18 is an isometric view of an alternate embodiment of the refuse receptacle with wheeled dolly;

FIG. 19 is an isometric view of an alternate embodiment of the refuse receptacle with wheeled dolly;

FIG. 20 is a top left isometric view of an alternate embodiment of a commercial grade refuse receptacle and wheeled dolly;

FIG. 21 is a partial view of a base handle which also functions as an attachment for the wheeled dolly for the receptacle illustrated in FIG. 20;

FIG. 22 is a bottom isometric view of the refuse receptacle illustrated in FIG. 20;

FIG. 23 is a partial bottom isometric view of a base handle and base of the refuse receptacle illustrated in FIG. 22;

FIG. 24 is a side view of the refuse receptacle with wheeled dolly illustrated in FIG. 20; and

FIG. 25 is a partial section view taken along lines 20-20 of FIG. 24, illustrating the engagement of the dolly clips with the base handle portion of the second alternate embodiment refuse receptacle.

### DETAILED DESCRIPTION OF THE INVENTION

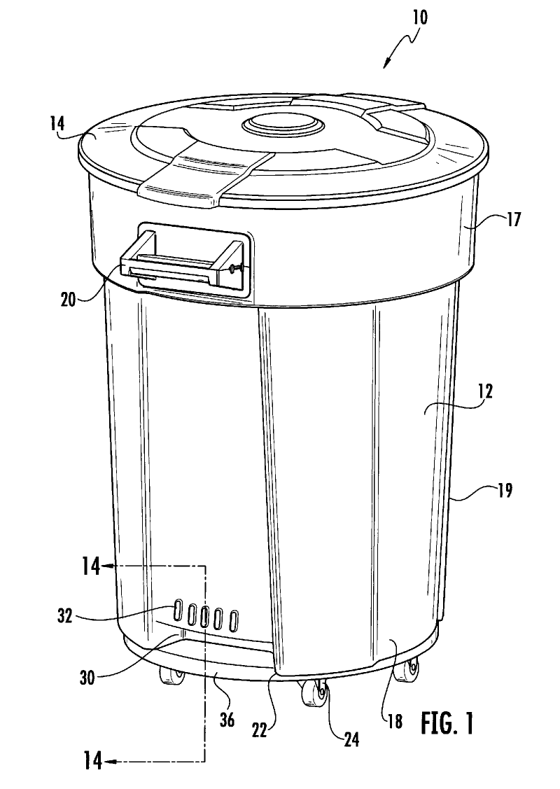

The present invention is a refuse receptacle (10). It can be manufactured in various sizes, including industry standard sizes of 20 gallons, 32 gallons, 44 gallons, and 55 gallons. As depicted in FIG. 1, the receptacle (10) can be equipped with a lid (14) and a wheeled dolly (36). The body (12) has vents (18) which allow for air to connect an upper portion (17) with a lower portion (19) of the receptacle (10). The fluid communication provided by the vents (18) prevents negative pressure from building up inside the body (12) if a liner is used within the receptacle (10).

A handle (20) is attached to the body (12) in an upper portion of the receptacle, providing a user a place to grasp the receptacle (10) while using it. At the bottom (22) of the body, a base handle (30) is formed as an indentation along the bottom rim (24). This base handle (30) provides a gripping position for a user to invert the receptacle (10) to empty the contents contained therein. Grip identification markings (32) are included to provide an easy visual cue to allow a user to quickly identify the location of the base handle (30).

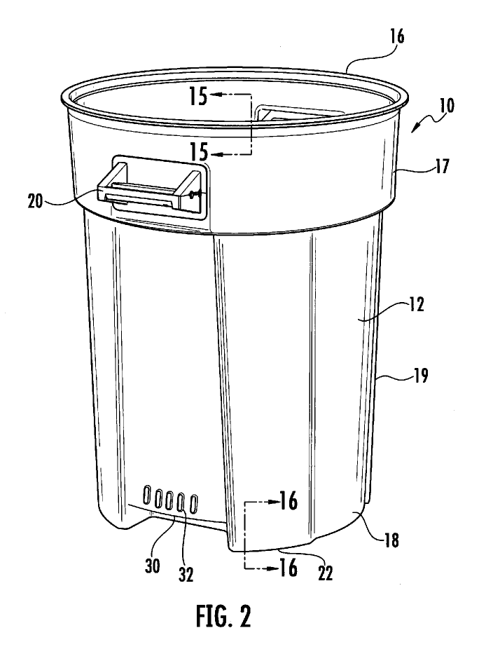

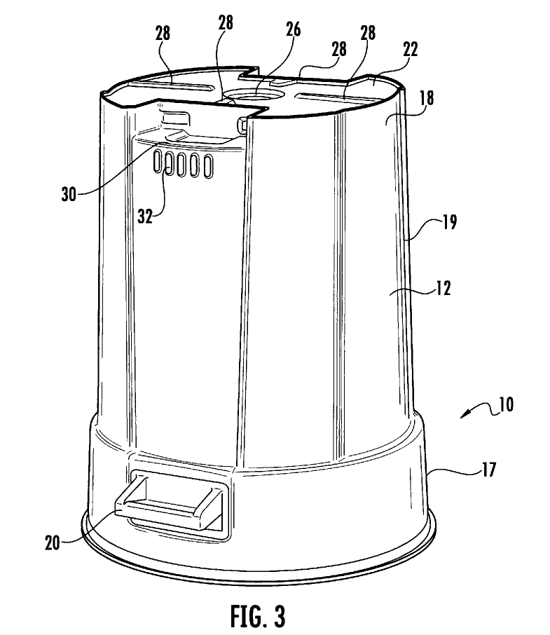

In FIGS. 2 and 3, the body (12) is shown so that the opening at the top rim (16) can be seen in FIG. 2 and the bottom (22) can be seen in FIG. 3. As shown, the base handle (30) is offset from the bottom (22) so that, if the body is resting on the ground, the user will not have to grasp the portion in contact with the ground. The bottom (22) further contains a dolly engagement groove (26) towards the center of the bottom (22) to help align the dolly (36) with the body (12) during attachment. The dolly engagement grooves (26) provide structural rigidity to the bottom portion of the receptacle. Additionally, there are integrally formed reinforcing beams (28) to increase structural integrity of the bottom (22). The reinforcing beams may extend through or out of the dolly engagement grooves or they may extend inwardly from the outer perimeter of the receptacle towards the center thereof.

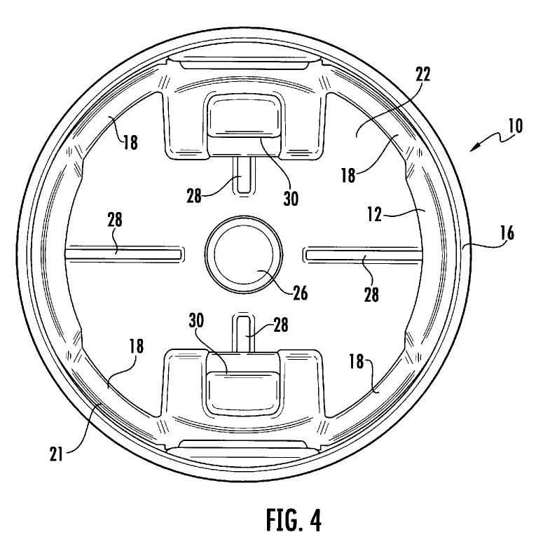

FIG. 4 is a top view into the receptacle (10) through the opening at the top portion (21) of the body (12). As shown, some offset portions of the body (12) are positioned closer to the center of the receptacle (10), while some offset portions are positioned slightly farther from the center of the receptacle (10). This staggering of portions of the body (12) creates vents (18) which allow for air to fluidly communicate between the open top portion (21) and the bottom (22) when a liner is used within the receptacle (10). This venting allows for easier removal of a liner by decreasing the negative pressure that can form at the base of the receptacle when a liner is removed from a receptacle.

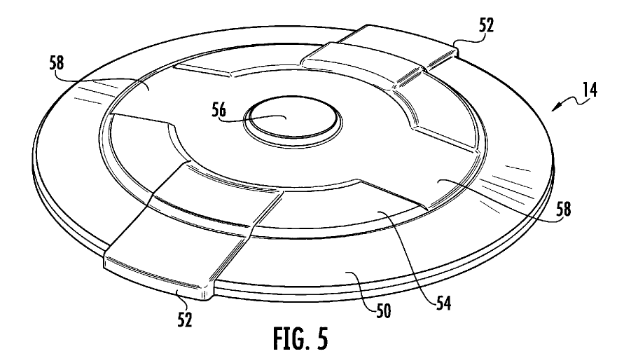

A lid (14), as shown in FIG. 5, can be employed to cover the top of the receptacle, preventing some odors from emanating from within the receptacle (10), as well as preventing any waste contained within the receptacle (10) from spilling out. The receptacle lid (14) can attach to the top rim (16) of the body (12). The lid (14) is formed with multiple ring portions at different levels, to form a tiered shape allowing for water to run off the lid (14) and away from the receptacle (10). A first ring portion (50) forms the outer region and contains handles (52) which can be employed to separate the lid (14) from the top rim (16) of the receptacle (10). A second ring portion (54) is raised slightly from the first ring portion (50) and is positioned concentrically within the first ring portion (50). The second ring portion also contains channels (58) to allow water to run off of the lid (14). A third ring portion (56) is positioned at the center of the lid (14) and is raised slightly from the second ring portion (54). This multi-level design assists in controlling the run-off of water from the lid (14).

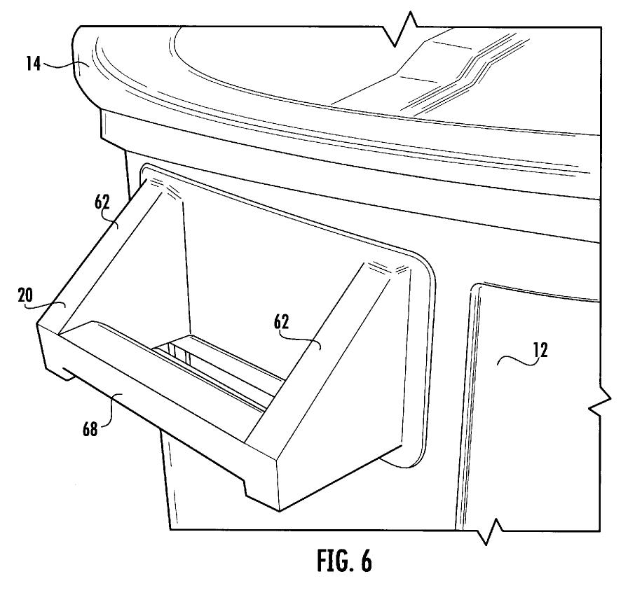

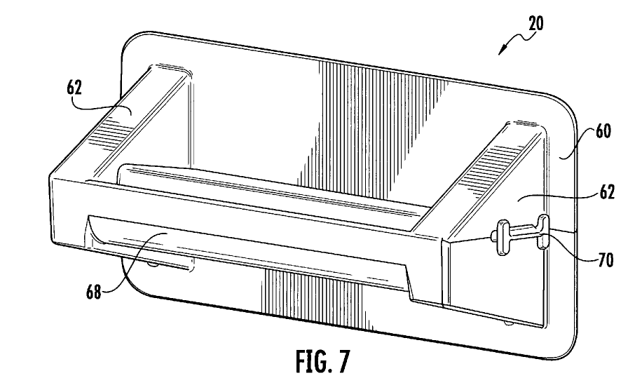

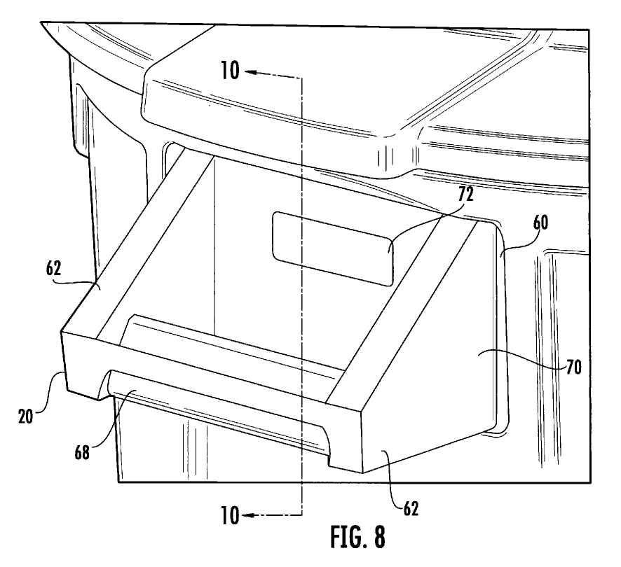

FIGS. 6-10 show the mating of an attached handle (20) to the body (12). In the preferred embodiment of the receptacle (10), the body (12) is formed by extrusion blow molding and the handle (20) is formed by injection molding. One novel feature of the present invention is the mating of the injection molded handle (20) to the extrusion blow molded body (12).

The handle (20) is formed from a base plate (60), from which a pair of opposing sidewalls (62) project out from the front surface. A gripping portion (68) extends between the opposing sidewalls (62). On the outside of one of the sidewalls, a cinch (70) is shown which can be used to tie off a liner used within the receptacle (10). The base plate can include a logo aperture (72) so that, during the formation of the body (12), while the body is mating to the handle (20), a portion of the parison can pass through the logo aperture (72) and press against the mold to form a company logo.

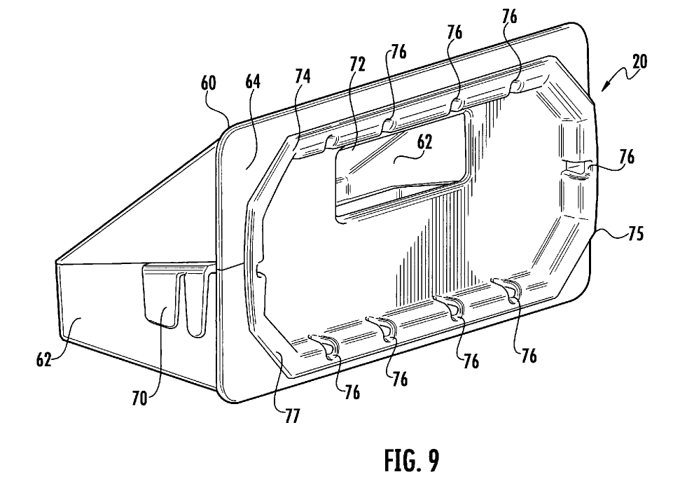

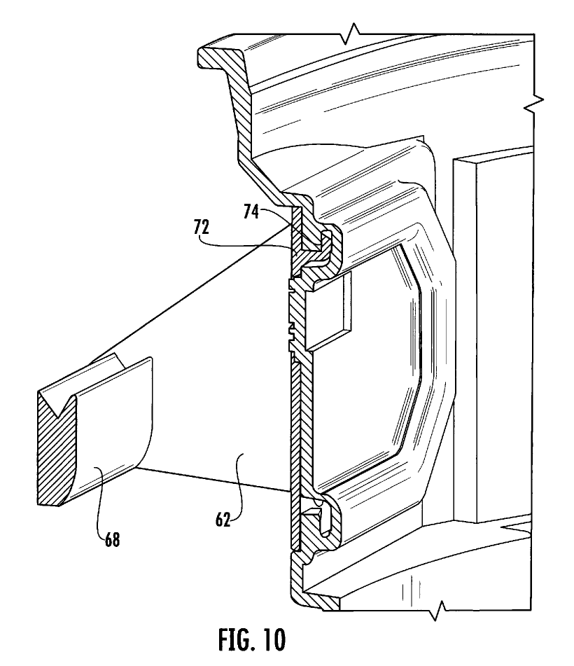

The base plate back side (64) contains at least one mating projection (74). As shown in FIG. 9, a preferred mating projection (74) is an undercut ring extending around the perimeter of the base plate back side (64). Alternatively, a plurality of projections can be incorporated at various points spread across the back side. As seen in FIGS. 9 and 10, the preferred embodiment includes an annular projection extending out from the base plate (60), a depending extension region (75) which extends outwardly and an anchor region (77) where the projection (74) curves back towards the base plate. It should be noted that other shapes suitable for receiving blow molding plastic thereabout in a blow molding machine may be substituted without departing from the scope of the invention. Such shapes may include, but should not be limited to, polygons, ovals, circles and the like which may be continuous or broken into segments.

During formation of the body (12), the handle (20) is presented into the mold so that the mating projection (74) is disposed towards the parison (not shown). When air pressure fills the parison and expands it out to fill the mold, the parison wraps around the mating projection (74), locking it into the body (12) itself. Apertures, or shutoffs, (76) are molded into the mating projection (74), allowing the parison plastic to interlock with the handle (20).

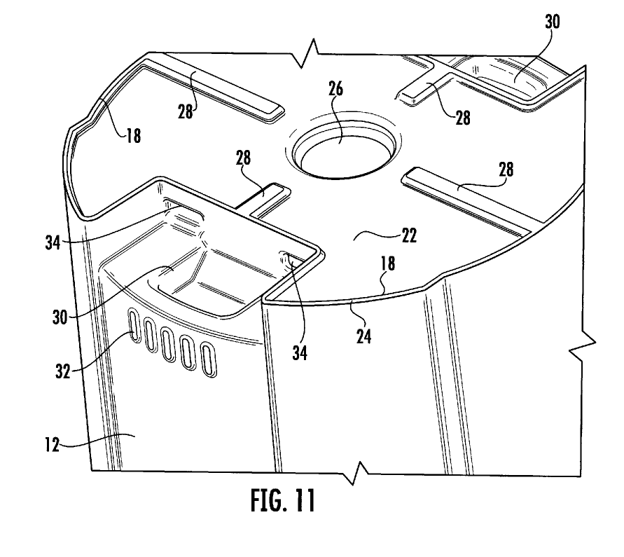

In FIG. 11, the receptacle bottom (22) can be seen. The bottom (22) contains a rim (24), an engagement groove (26), reinforcing beams (28), and a base handle (30) that is offset from the plane that the rest of the bottom (22) is on. The base handle (30) is shown located between vents (18), and is indented from the rest of the bottom (22) so that when the receptacle (10) is placed on the ground, the handle (30) is still accessible to a user. The user can quickly identify the location of the handle (30) because of the grip identification markings (32) on the body (12) at the base handle (30). The dolly engagement groove (26) allows an attachable dolly to be lined up with the receptacle (10) for engagement. Each base handle (30) has dolly engagement slots (34) for further engagement with the dolly (36).

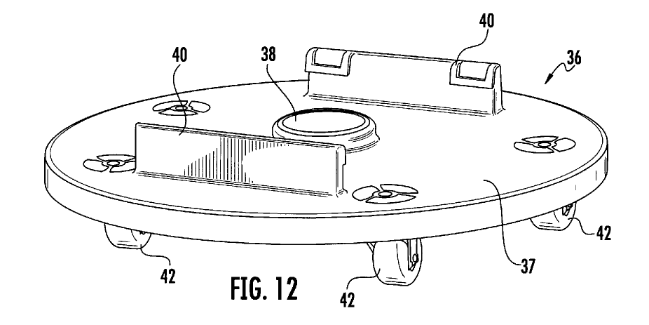

The dolly (36) is shown in FIG. 12 with a base (37) supported by wheels (42). A central positioning projection (38) can be seen at the center of the pictured dolly (36). The dolly (36) further contains clips (40), which allow the dolly to attach to the dolly engagement groove (26) at the base handles (30) of the receptacle (10). When engaged, the dolly (36) supports the receptacle (10) off of the ground, and secures it at the dolly engagement groove (26) of the base handles (30) with the clips (40), as seen in FIG. 13.

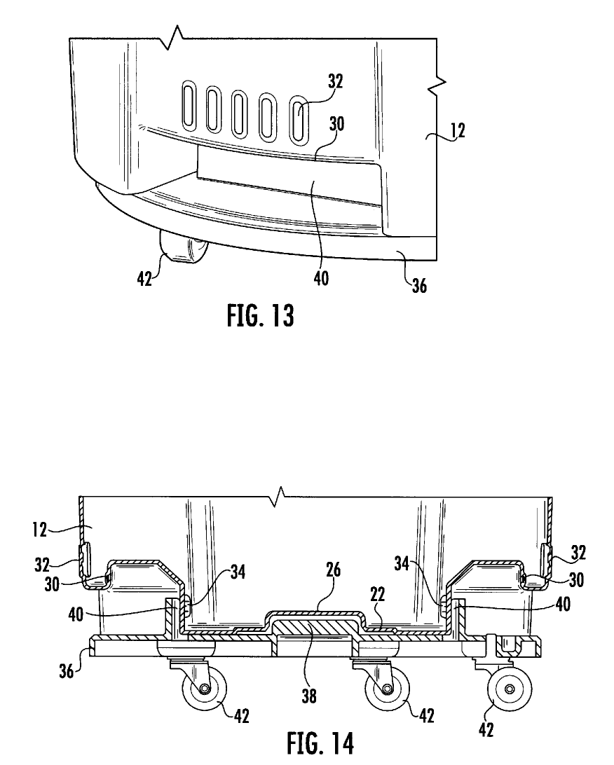

In FIG. 14, this engagement is shown more clearly. The positioning projection (38) on the dolly (36) lines up with the dolly engagement groove (26) on the receptacle bottom (22). The clips (40) then snap into the dolly engagement slots (34) in the base handle (30). The opposing forces from the clips (40) securely hold the receptacle (10) on the dolly (36). This prevents the receptacle (10) from moving with respect to the dolly base (37). The clips (40) then snap into the dolly engagement slots (34), to prevent the receptacle (10) from separating from the dolly (36).

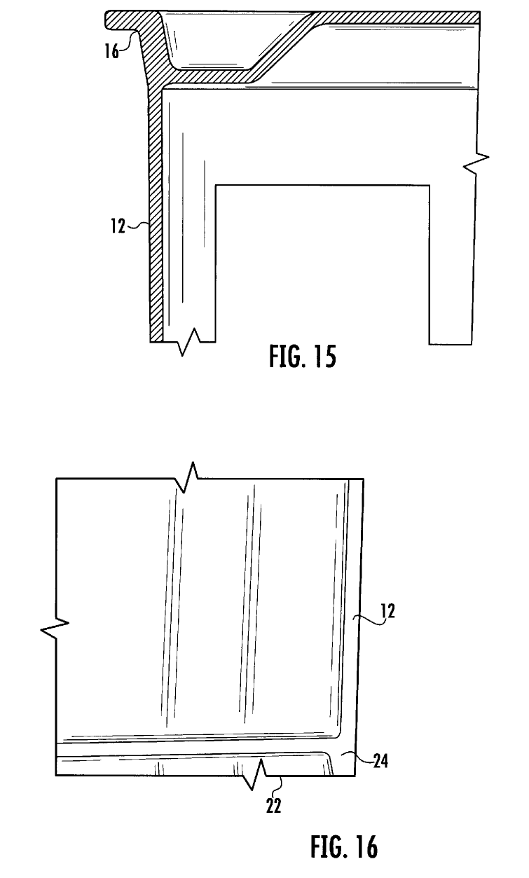

Another novel feature of the receptacle (10) is found at the top rim (16) and bottom rim (24). As seen in FIG. 15, the top rim (16) of the receptacle (10) is formed by a mold side or slide action which compresses the blown parison walls together to form a thick “L” shaped cross section. This provides an attachment surface for the lid (14) to attach to, and significantly adds to the strength and rigidity of the top and bottom of the receptacle (10). This compression strengthened rim runs around the perimeter of the top rim (16). In FIG. 16, the bottom rim (24) is shown formed from a similar side or slide action to create a wear rib along the base of the receptacle to structurally strengthen the bottom rim (24). This compression strengthened bottom rim (24) prevents wear from potential dragging of the receptacle (10) across the ground surface.

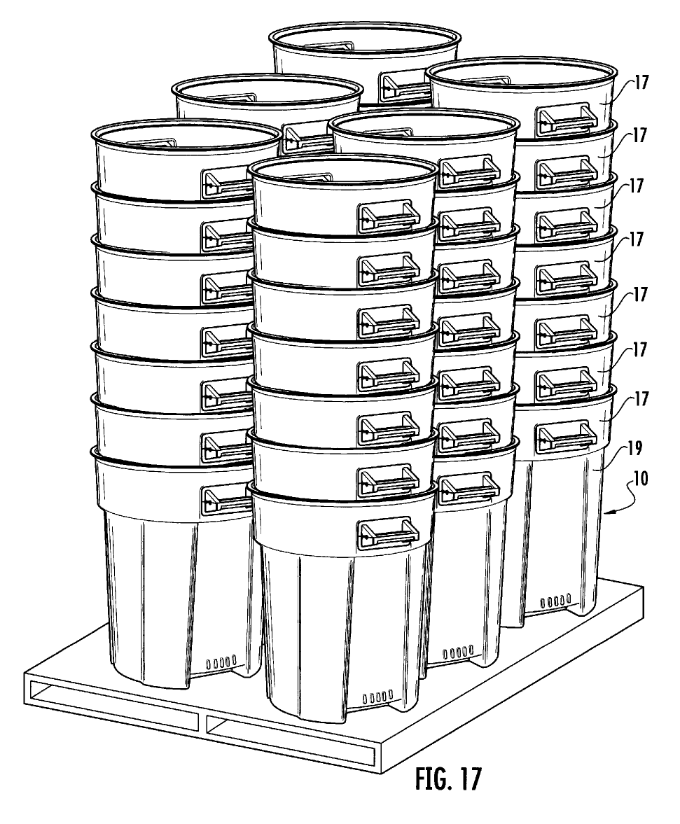

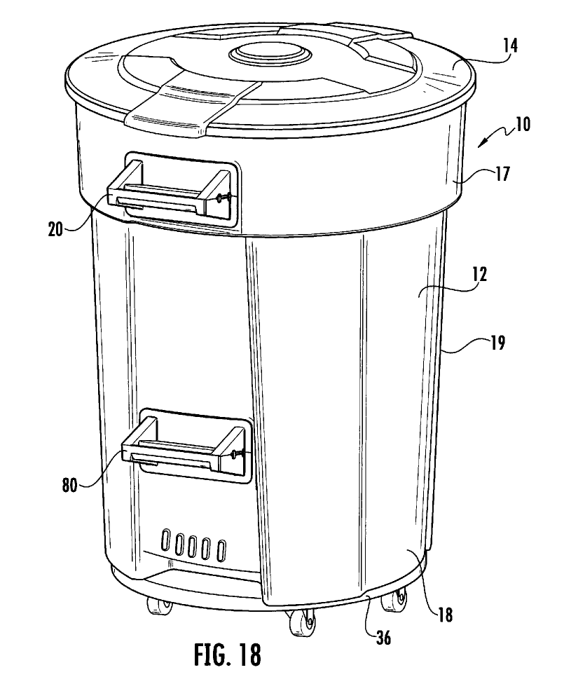

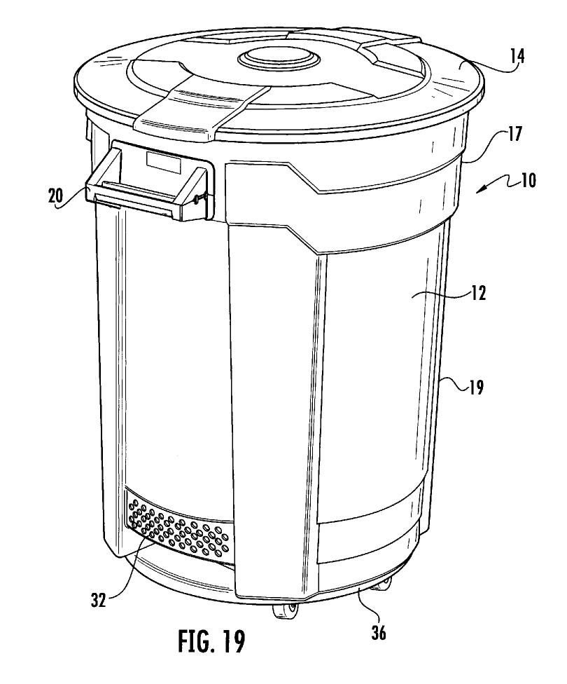

The lower portion (19) of the receptacle (10), as is customary with similar receptacles (10), can taper as the body (12) approaches the bottom (22). This tapering allows multiple receptacles (10) to stack together in a nested configuration, as shown in FIG. 17. Alternatively, as seen in FIG. 18, an optional handle (80) can be mated to the lower portion (19) during the formation process in the same way that handle (20) is attached to the upper portion (17), as described above. This optional handle (80) is beneficial on receptacles (10) of greater volume because of the increased weight generally carried within the receptacle (10). FIG. 19 shows an alternate embodiment with an alternate design for the upper portion (17) and the grip markings (32).

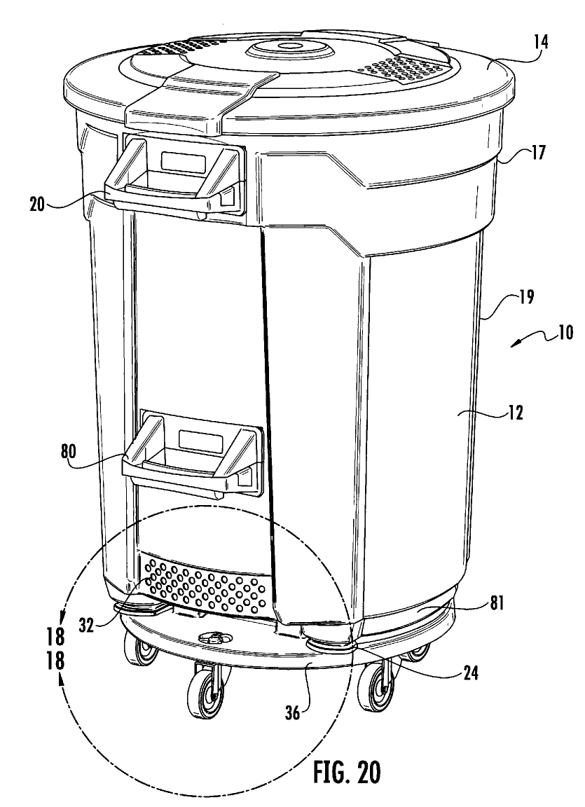

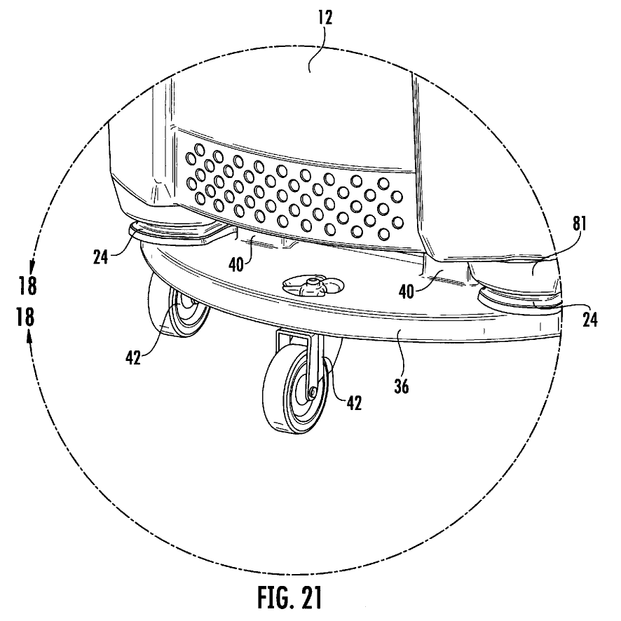

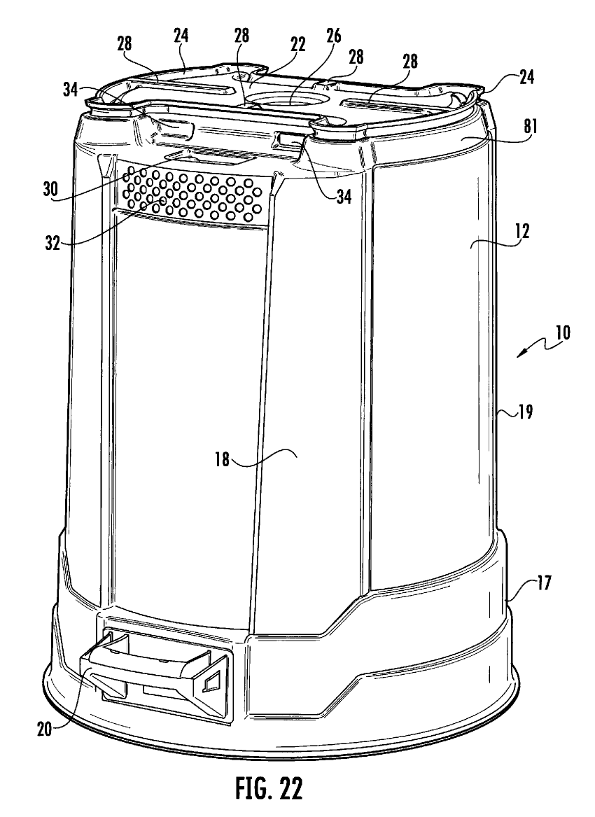

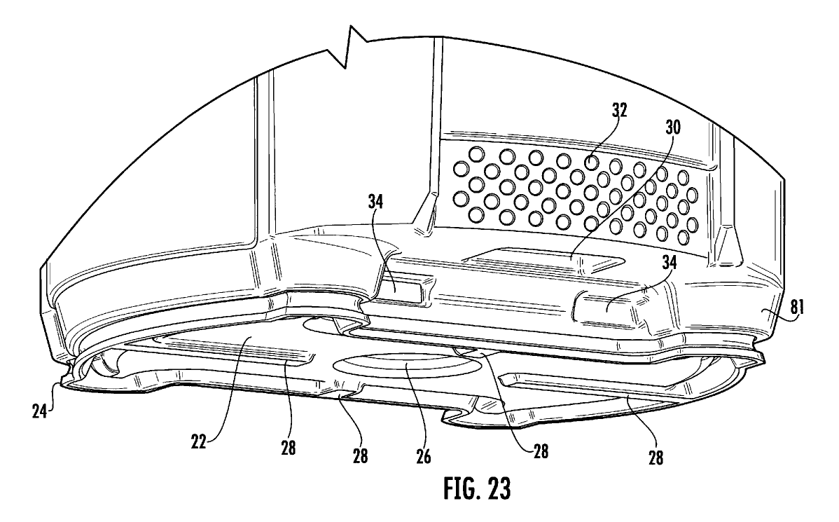

FIG. 20-25 shows an alternate embodiment refuse receptacle (10). Like the embodiment shown in FIG. 19, the upper portion (17) includes an alternate tiered design and the body (12) includes an alternate style of grip markings (32). In the embodiment shown in FIG. 20, an optional handle (80) can be incorporated into the body (12) of the receptacle (10). FIG. 21 highlights some of the differences in this embodiment from the prior embodiments. This embodiment includes a pair of dolly clips (40) on opposing sides of the receptacle (10), as opposed to the longer dolly clip show in early embodiments. Additionally, this embodiment has a tapered lower portion (81) leading to a bottom rim (24) that is compression strengthened into and C-shaped for added strength and rigidity, shown more clearly in FIGS. 22-23.

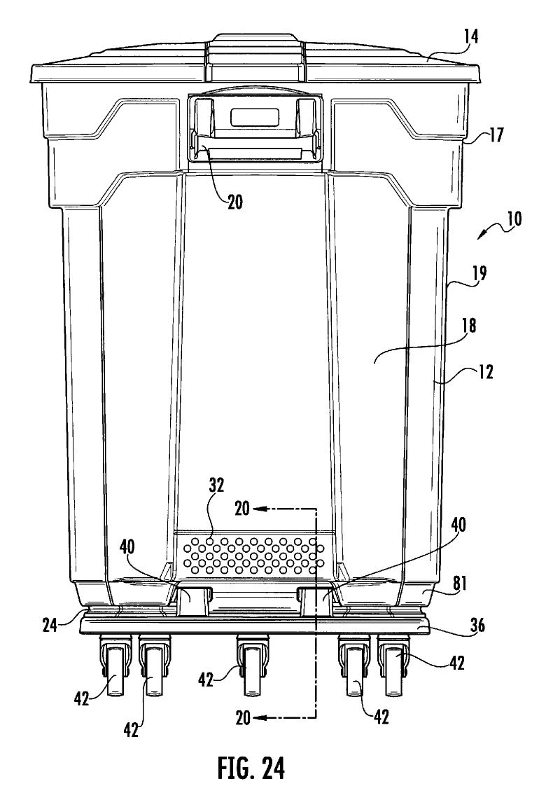

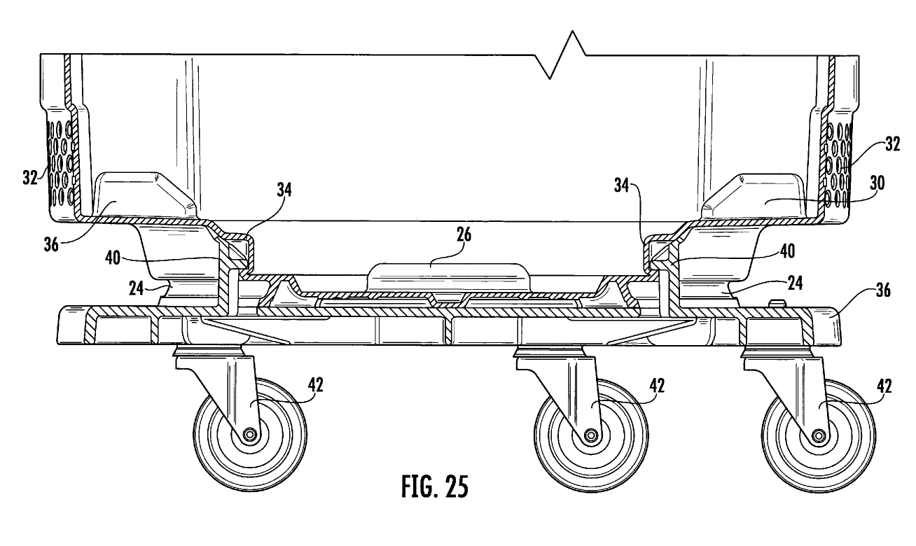

FIG. 24 is a side view this embodiment of the receptacle (10), showing the relationship between the attached handle (20) on the upper portion (17), the grip identification markings (32), the dolly (36) attached by the dolly clips (40) in close proximity to the level of the body (12) where the tapered lower portion (81) leads into the reinforced bottom rim (24). A series of wheels (42) allows the dolly (36) to support and easily move the receptacle (10). FIG. 25, a cross sectional view taken along line 20-20 from FIG. 24, additionally illustrates the interaction of the dolly engagement groove (26) with the dolly (36), as well as illustrating the base handles (30) on opposite sides of the body (12).

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention, and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

1. A receptacle comprising:
a body configured to receive refuse items, said body having a first open end and a second closed end;
a rim at said first open end of said body;
at least one handle mated to said body comprising a base plate with a front side and a back side, at least one sidewall projecting out of said front side of said base plate, a gripping portion supported by said at least one sidewall, said back side of said base plate having at least one mating projection, said at least one mating projection projecting out of said back side of said base plate, said at least one mating projection having an extension region projecting out of said back side of said base plate and an attachment region offset from said extension region.

2. The handle according to claim 1, wherein said at least one mating projection forms a ring on said back panel.

3. The handle according to claim 2, wherein said at least one mating projection has a plurality of apertures.

4. The handle according to claim 1, further comprising an aperture on said base plate, whereby said body of said receptacle can expand through during the mating of said handle to said body, said body fills the space to display a logo or other marking.

5. The handle according to claim 1, further comprising a cinch disposed on said at least one sidewall projection.

6. The handle according to claim 1, wherein said body is blow-molded around said at least one mating projection such that a sidewall of said body envelops said at least one mating projection forming said sidewall around said mating projection to mate said handle to said body sufficiently to withstand normal operating forces without said handle being removed from said body.

7. The body according to claim 1, wherein said body has an upper portion and a lower portion.

8. The body according to claim 7, further comprising at least one vent providing fluid communication between said second closed end of said body and said first open end of said body.

9. The body according to claim 1, further comprising a reinforced rim at the top of said body, said reinforced rim comprising a second layer of plastic along a top portion of said body to increase the strength of said body.

10. The body according to claim 9, further comprising a reinforced edge at the base of said body, said reinforced edge comprising a second layer of plastic along a bottom portion of said body to increase structural integrity and wear protection of said body.

11. The body according to claim 1, further comprising at least gripping indentation, said gripping indentation formed at a junction between a sidewall of said body and a bottom surface of said body, said bottom surface located at said second closed end of said body, said gripping portion having a horizontal surface projecting toward an inside of said body, a backwall extending from said horizontal surface to said second closed end of said body, and a pair of opposing said sidewalls.

12. The body according to claim 11, wherein said backwall contains a concave indentation configured for attachment to an attachment prong of an attachable dolly.

13. The method of forming a receptacle with an attached handle comprising:
extruding parison into chamber, said chamber including a mold of the desired shape of said receptacle, said chamber further including a handle comprising a base plate with a front side and a back side, at least one sidewall projecting out of said front side of said base plate, a gripping portion supported by said at least one sidewall, said back side of said base plate having at least one mating projection, said at least one mating projection projecting out of said back side of said base plate, said at least one mating projection having an extension region projecting out of said back side of said base plate and an attachment region offset from said extension region;
inserting a blower into an inner portion of said parison;
blowing air into said inner portion of said parison to expand said parison outward to fill the chamber and attach around said at least one mating projection of said handle;
opening said chamber;
cooling said parison;
trimming off said excess parison from the newly formed receptacle with attached handle.
